(19) United States
(12) Patent Application Publication
(10) Pub. No.: US 2026/0183189 A1
(43) Pub. Date: Jul. 2, 2026

(54) Portable Sauna Device

(71) Applicant: Bjorn Capital Group LLC, Dover, DE (US)

(72) Inventor: Simon Bjoern-Henriksen, Dover, DE (US)

(21) Appl. No.: 19/003,111

(22) Filed: Dec. 27, 2024

(51) Int. Cl. A61H 33/06

(52) U.S. Cl. CPC A61H 33/067; A61H 33/063; A61H 2033/061; A61H 2201/0157; A61H 2201/0207; A61H 2201/025; A61H 2201/5046; A61H 2203/0431

(57) ABSTRACT

A portable sauna system disclosed herein may include a collapsible cabin structure having an organic cotton shell and insulation layer, a modified heater capable of reaching temperatures between 192-195° F., a custom mounting system having a custom bracket for attaching the modified heater to the cabin frame, and a thermostat-enabled heater interface having a timer for automatic shutoff.

### FIELD OF USE

Aspects of the disclosure relate to sauna systems. In particular, portable sauna systems and devices are disclosed herein.

### BACKGROUND

Saunas are widely recognized for their therapeutic and relaxation benefits. However, traditional saunas are often bulky, immobile, and require dedicated installation spaces, which limits accessibility and convenience for users who seek portable solutions.

Existing portable saunas typically rely on proprietary heating systems or complex setups, which can be costly or impractical. The present disclosure combines simplified and inexpensive components and lightweight materials into an innovative and efficient portable sauna system that addresses these challenges.

### SUMMARY

In light of the foregoing background, the following presents a simplified summary of the present disclosure in order to provide a basic understanding of various aspects of the disclosure. This summary is not limiting with respect to the exemplary aspects of the inventions described herein and is not an extensive overview of the disclosure. It is not intended to identify key or critical elements of the disclosure or to delineate the scope of the disclosure. Instead, as would be understood by a personal of ordinary skill in the art, the following summary merely presents some concepts of the disclosure in a simplified form as a prelude to the more detailed description provided below.

In one general aspect of this disclosure, a portable sauna system may include a collapsible cabin structure formed from a metal frame and an insulated organic cotton shell designed to retain heat efficiently. In one example, the shell may be fireproof and waterproof. In some examples, a modified heater capable of reaching temperatures between 192-195° F. (89-91° C.) may be included on the interior of the cabin structure. In one example, a mounting system may be configured to engage the modified heater within the interior of the cabin structure. In certain examples, the mounting system may include a custom bracket configured to securely attach the heater to the cabin structure frame. In other examples, the heater may include thermostat-enabled heater interface and a timer for automatic shutoff and temperature regulation, ensuring user safety and convenience.

In another aspect of the disclosure, a portable sauna system may include a cabin structure, a cabin frame configured to engage the cabin structure, a heating system including a protective barrier positioned on a top portion of the heating system, and a heater mounting bracket configured to removably engage the heating system and the cabin frame. The protective barrier may further include a rear guard, a front guard, and a center guard in which the rear guard comprises a horseshoe shape having a varying rear wall height and forming a front gap configured to engage the front guard that may be curvilinear having a single height, and the front guard closes/engages the horseshoe gap, and the center guard may be spiral shaped and may include support ribs to facilitate optimized airflow circulation.

In some examples, the cabin frame comprises a series of collapsible metal poles configured to engage a top and a bottom, and wherein the top and the bottom comprise a metal. In one example the cabin structure may be collapsible. In other examples, the cabin structure comprises a material having an internal cotton insulation layer, and the cabin structure material may also include a dimpled pattern on an exterior of the material and on an interior of the material to increase rigidity of the material and cabin structure. In still other examples, the cabin structure may further include an entry flap configured to close an entrance of the cabin structure, and the entry flap may include a closure device. In certain examples, the closure device may be a zipper or a magnet. In one example, the entry flap may include a flap perimeter gasket configured to engage an entry perimeter gasket of the entrance. In yet another example, the flap perimeter gasket may include an internal magnet, and the entry perimeter gasket may include an internal magnet, and the flap perimeter gasket may be secured to the entry perimeter gasket by a magnetic force. In other examples, the heating system may include a touchscreen interface, wherein the user interface is a touchscreen. In another example, the heating system may further include a thermostat.

In other aspects of the disclosure, a sauna system may include a cabin structure including an entryway flap that forms an opening for an occupant to enter and exit the cabin structure, and the entryway flap may be configured to seal the opening. The sauna system may also include a cabin frame configured to engage the cabin structure, a heating system, and a heater mounting bracket configured to removably engage the heating system and the cabin frame.

In some examples, the cabin structure is collapsible. In other examples, the cabin structure further includes a top and a bottom, and wherein the top and the bottom comprise a metal. In one example, the heating system may include a user interface touchscreen. In other examples, the heating system comprises a guard, the heating system may be battery powered, and the heating system may be removably coupled to a mounting bracket. In still other examples, the mounting bracket may be movably coupled to the cabin frame, and a chair may be configured to seat an occupant within the cabin structure.

In yet another aspect of the disclosure, a kit for a portable sauna system may include a cabin structure, a cabin frame configured to engage the cabin structure, a heating system including a protective barrier positioned on a top portion of the heating system, a heater mounting bracket configured to removably engage the heating system and the cabin frame, and printed instructions in which each component is combined into a unitary packaging assembly. In certain examples, the protective barrier may further include a rear guard, a front guard, and a center guard in which the rear guard includes a horseshoe shape forming a front gap and a rear wall having a varying rear wall height in which a maximum rear wall height is positioned adjacent the cabin structure material, the front guard may be configured to engage the front gap and the front guard is curvilinear having single height, and the center guard may include a series of support ribs, and the center guard may be spiral shaped and include a series of support ribs.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates a front view of the assembled sauna cabin of a portable sauna system as disclosed herein.

FIG. 2 illustrates a perspective view of the assembled sauna cabin of a portable sauna system as disclosed herein.

FIG. 3 illustrates a front view of the assembled sauna cabin of a portable sauna system as disclosed herein.

FIG. 4A illustrates a front view of a sauna cabin with the entryway opened and illustrating the interior of a sauna cabin of a portable sauna system as disclosed herein.

FIG. 4B illustrates the heater system and user interface from the interior of FIG. 4A of the assembled sauna cabin of a portable sauna system as disclosed herein.

FIG. 5A depicts a front view of a heater system including a user interface and a protective cover/guard of a portable sauna system as disclosed herein.

FIG. 5B depicts a perspective view of heater system including a heating element, user interface, and protective cover/guard shown in FIG. 5A of a portable sauna system as disclosed herein.

FIG. 5C depicts a perspective view of heater system including a heating element, user interface, and protective cover/guard shown in FIG. 5A of a portable sauna system as disclosed herein.

FIG. 5D depicts a rear-perspective view of heater system including a mounting bracket shown in FIG. 5A of a portable sauna system as disclosed herein.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

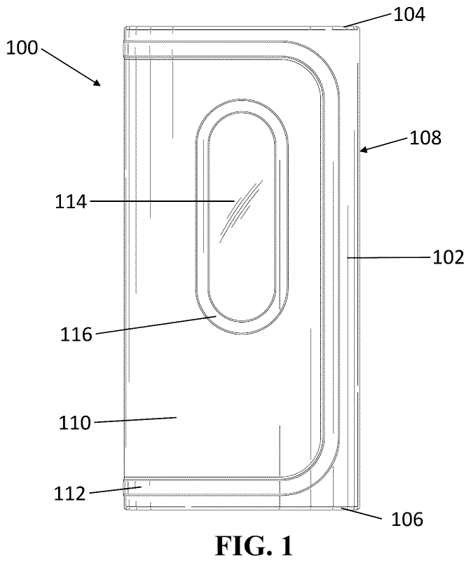

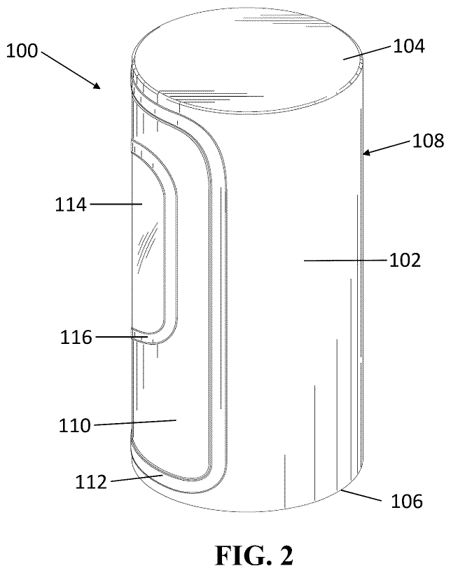

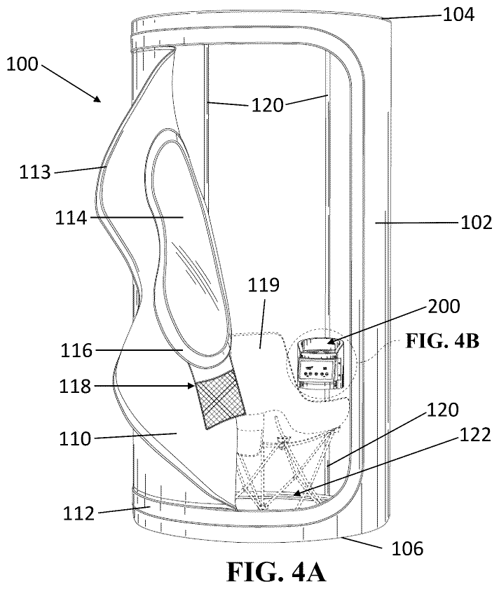

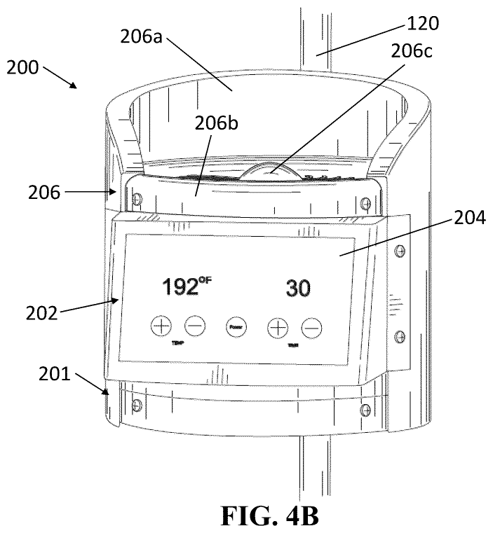

As shown in FIGS. 1 and 2, portable sauna system 100 may include cabin 102. Cabin 102 may consist of a lightweight, collapsible metal frame, including circular top 104, a circular bottom 106, and vertical support or vertical frame members 120 (see FIG. 4A) forming a cabin frame. Sauna cabin 102 may include rear side 108. Cabin 102 may be generally cylindrical shaped and may be formed from a material forming an outer shell. The outer shell may be crafted from organic cotton, with an insulating cotton layer sandwiched between an inner layer and the outer layer to enhance heat retention. In some examples, cabin 102 may be formed from a shell of a nylon material or other polymer. In some examples, a foam insulation layer may be positioned between an inner and outer cotton layer forming the shell. In some examples, the inner and/or outer layer may be formed of a nylon or other polymer material with an insulation layer between. Cabin 102 may also include flap 110 having a gasket 112 forming an entrance to cabin 102 and may be configured to seal the entrance to cabin 102. Gasket 112 may be formed of a rubber or other polymer. Flap 110 may also include a window 114 formed of a plastic or other clear polymer. Window 114 may be secured to flap 110 via support member 116 extending around the perimeter of window 114. Support member 116 may be formed of a rubber or other polymer. In other examples, support member 116 may be formed of additional material forming cabin 102 such as a nylon or organic cotton. Window 114 may be secured to support member 116 via stitching, welding, adhesive, and/or mechanical fastener. In some examples, support member 116 may include a fastener element such as a tongue and groove, press-fit, Velcro, or mechanical fastener such as buttons or snaps to allow a user to open window 114. In some examples, support member 116 and/or window 114 may include zipper teeth and a pull to form a zipper-type fastener element to allow a user to open and close window 114. In another example, support member 116 and or window 114 may be formed with an internal magnet or magnets positioned along a perimeter of the support member 116 and/or window 114. In other examples, support member 116 and/or window 114 may include the above closure and opening systems and may be configured to engage flap 112 along an outer perimeter of window 114 and/or support member 116 to allow a user to open/close the window 114.

As shown in FIG. 2, the top 104 and/or bottom 106 may be generally circular shaped and may be formed of a metal, PVC, another polymer, a composite, or combinations thereof. Top 104 and bottom 106 may be supported by a circular frame members 122 (see FIG. 4A) formed of a metal, a polymer, a composite, or combinations thereof. The circular frame members 122 may be configured to removably engage vertical frame member(s) 120 to form the cabin frame. Disconnecting frame members 120 and 122 allow cabin 102 to be collapsed into a compressed configuration for storage or transport. In another example, top 104 and bottom 106 may be formed of a series of sections or quarters that may be detachable from one another for storage. Top 104 and bottom 106 may be formed of four sections that have a series of engagement points that allow the sections or pieces to be connected to each other by a click or press fit engagement. In some examples, top 104 and bottom 106 may be interchangeable. In another example, top 104 and bottom 106 may include a connection point configured to removably engage frame member 120. In some examples, cabin 102 may be supported by four frame members 102 engaged with each section or piece of top 104 and bottom 106.

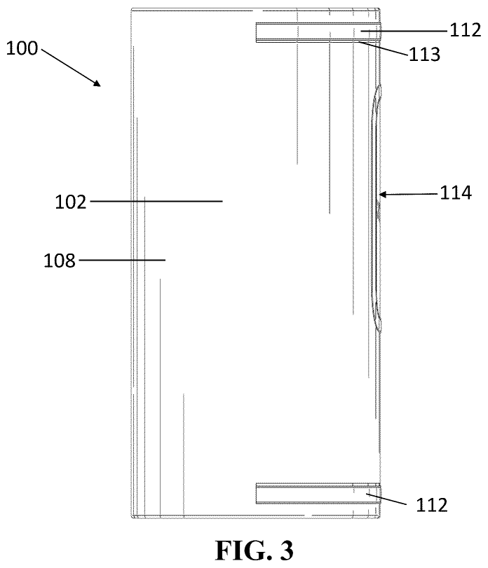

As shown in FIG. 3, gasket 112 of cabin 102 may extend to a point mid-way to the rear side 108 of cabin 102. Gasket 112 may be configured to engage a flap gasket 113 on flap 110 as shown in FIGS. 3 and 4A. Flap gasket 113 may be formed of a rubber or other polymer and may be positioned around the perimeter of flap 110. As also shown in FIGS. 3 and 4A, cabin gasket 112 and flap gasket 113 may have the same length or travel the same distance to ensure a proper seal of flap 110 when the flap is secured in a closed position. Cabin gasket 112 and flap gasket 113 may include a fastener element such as a tongue and groove, press-fit, Velcro, or mechanical fastener such as buttons or snaps. In some examples, cabin gasket 112 and flap gasket 113 may include zipper teeth and a pull to form a zipper-type fastener element. In another example, cabin gasket 112 and flap gasket 113 may be formed with an internal magnet or magnets positioned along a length of the cabin gasket 112 and flap gasket 113. The magnet or magnets (not shown) may be overmolded with rubber or other polymer forming the cabin gasket 112 and flap gasket 113. In other examples, cabin gasket 112 and flap gasket 113 may be formed of a nylon or cotton material and the magnets may be embedded within layers of the material via stitching, welding, or adhesive.

The design of sauna system 100 ensures portability, allowing users to easily assemble and disassemble cabin 102 for storage or transport. As shown in FIG. 4A, top 104 and bottom 106 may be supported by circular frame members 122. Frame members 122 may be integrally formed with top 104 and bottom 106 and may be configured to removably engage frame member(s) 120 to form the cabin frame. Frame members 120 may extend vertically along a height of cabin 102. Frame members 120 may be formed or segmented pieces and may be disassembled for easy storage. Disconnecting frame members 120 and 122 allow cabin 102 to be collapsed into a compressed configuration for storage or transport. Cabin 102 may include at least four frame members to support the structure. Vertical frame members may comprise a metal, a polymer, a composite, or combinations thereof. In certain examples, a user may assemble the cabin 102 frame members 120 with top 104 and bottom 106 (and/or circular frame members 122) outside cabin 102. As shown in FIGS. 2 and 3, flap 110 may be configured to open about 180° allowing a user to then easily insert assembled frame members 120, top 104, and bottom 106 into cabin 102. In one example, flap 110 may be configured to open, for example, at least, greater than, less than, equal to, or any number in between about 135°, 136°, 137°, 138°, 139°, 140°, 141°, 142°, 143°, 144°, 145°, 146°, 147°, 148°, 149°, 150°, 151°, 152°, 153°, 154°, 155°, 156°, 157°, 158°, 159°, 160°, 161°, 162°, 163°, 164°, 165°, 166°, 167°, 168°, 169°, 170°, 171°, 172°, 173°, 174°, 175°, 176°, 177°, 178°, 179°, and 180°.

As also shown in FIG. 4A, a pocket 118 for securing a user's items such as keys or a cell phone may be positioned below window 114 and secured to may be secured to support member 116 via stitching, welding, adhesive, and/or mechanical fastener. A portable chair or camping chair 119 may be included on the interior of cabin 102 for an occupant to sit in while the sauna system 100 is in use. Heater system 200 may be positioned adjacent to where an occupant my sit within cabin 102. In one example, an LED red light may be attached inside cabin 102 and configured to receive power from the heater system 200. In other examples, an LED white light may be positioned inside cabin 102.

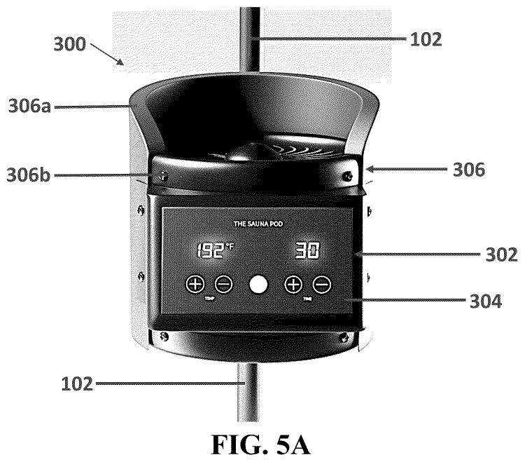

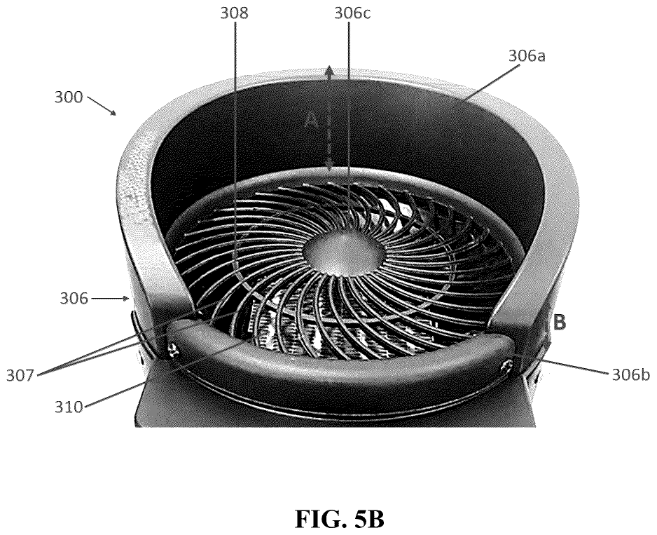

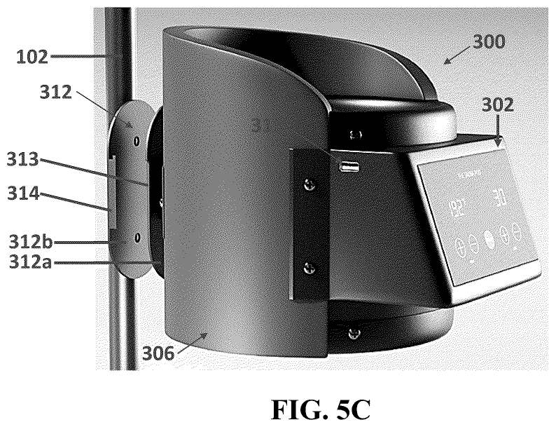

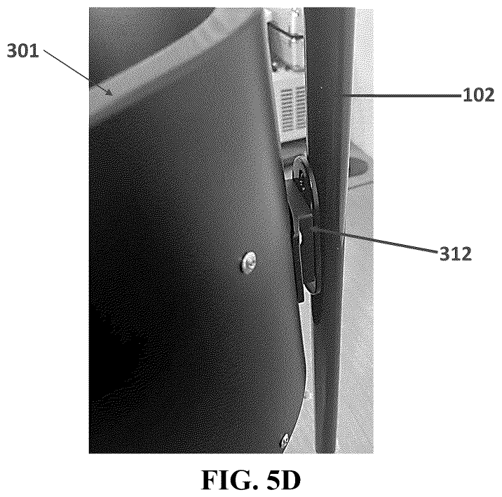

As shown in FIG. 4B, heater system 200 may be affixed to vertical frame member 120. Heater system 200 may include main housing 201 that supports and encloses the sauna heater components, ensuring structural integrity and durability. In some examples, main housing 201 may include a fan (not shown) located centrally within the main housing 201. The fan may consist of blades radiating from the center to ensure efficient air circulation over a heating element. Heating element or coil (see FIG. 5B element 310) may be positioned within main housing 201. In some examples, the fan may be positioned below heating element 310. The heating element generates the required thermal energy to heat the air. Heating system 200 may include a user interface 202 having a touch screen control panel 204 for adjusting temperature, timers, and fan settings (if present). A protective cover or guard 206 may surround the heating element at a top portion of housing 201, safeguarding the fabric cabin walls from heat damage.

Heater system 200 may be capable of achieving temperatures up to 195° F., surpassing standard heaters limited to approximately 100-110° F. Heater system 200 may include a modified internal thermostat, allowing for extended heating ranges. In one example, heater system 200 may achieve a temperature of, for example, at least, greater than, less than, equal to, or any number in between about 100° F., 101° F., 102° F., 103° F., 104° F., 105° F., 106° F., 107° F., 108° F., 109° F., 110° F., 111° F., 112° F., 113° F., 114° F., 115° F., 116° F., 117° F., 118° F., 119° F., 120° F., 121° F., 122° F., 123° F., 124° F., 125° F., 126° F., 127° F., 128° F., 129° F., 130° F., 131° F., 132° F., 133° F., 134° F., 135° F., 136° F., 137° F., 138° F., 139° F., 140° F., 141° F., 142° F., 143° F., 144° F., 145° F., 146° F., 147° F., 148° F., 149° F., 150° F., 151° F., 152° F., 153° F., 154° F., 155° F., 156° F., 157° F., 158° F., 159° F., 160° F., 161° F., 162° F., 163° F., 164° F., 165° F., 166° F., 167° F., 168° F., 169° F., 170° F., 171° F., 172° F., 173° F., 174° F., 175° F., 176° F., 177° F., 178° F., 179° F., 180° F., 181° F., 182° F., 183° F., 184° F., 185° F., 186° F., 187° F., 188° F., 189° F., 190° F., 191° F., 192° F., 193° F., 194° F., and 195° F. Heater system 200 may include a timer function that enables automatic shutoff after 30 or 60 minutes, or other time as set by the user. Heater system 200 may include a thermostat that cycles the heating element on and off to maintain the desired temperature, providing energy efficiency and user safety.

Guard 206 may form a curved or curvilinear protective barrier surrounding the heating element and may be designed to prevent accidental contact with the internal components of housing 201 while allowing adequate airflow. In some examples, guard 206 may be formed of multiple components to include rear guard 206a, front guard 206b, and center guard 206c.

FIG. 5A illustrates a front view of heater system 300 affixed to vertical frame member 120. Guard or protective cover 306 may surround a top portion of housing 301 above the internal heating elements, safeguarding the sauna cabin wall materials from heat damage. Heater system 300 may include a user interface 302 having a touch screen control panel 304 for adjusting temperature, timers, etc. as described above. Heater system 300 may have a double-walled construction as also shown in FIG. 4B to improve the safety measures of heater system 300.

As shown in FIGS. 5A and 5B, guard 306 may form a curved or curvilinear protective barrier surrounding the heating element at the top portion of heating system 300 and may be designed to prevent accidental contact with the internal components within housing 301 while allowing adequate and efficient airflow. In some examples, guard 306 may be formed of multiple components to include rear guard 306a, front guard 306b, and center guard 306c. Critically, the unique arrangement, positioning, shape, and design of rear guard 306a, front guard 306b, and center guard 306c provide advantages over prior art systems by providing enhanced protection for an occupant inside the sauna system and protection of the sauna system itself, and by providing enhanced airflow and heating of the interior of the sauna system.

As shown in FIG. 5B rear guard 306a may have a generally horseshoe or curvilinear shape forming a front gap. Rear guard 306a may include a rear wall having a varying rear-wall height, wherein a maximum rear wall height is positioned adjacent the cabin structure material as annotated in FIG. 5B by the segmented vertical arrow A on the rear side of housing 301. The wall height of rear guard 306a decreases to a low point adjacent front guard 306b as annotated by segmented vertical arrow B. Front guard 306b is configured to engage the front gap of rear guard 306a. Front guard 306b may be curved or curvilinear having a single, constant height. The specific heights of the rear guard 306a and front guard 306b maximize heated airflow towards a center of the sauna cabin and away from the cabin interior walls both providing efficient heated air for the user while maximizing safety by directing air away from the sauna cabin materials. Center guard 306c may include a series of support ribs 307 affixed to support ring 308. Center guard 306c and support ribs 307 may be generally spiral shaped. Center guard 306c provides protection for the occupant from accidentally contacting heating element 310. Again, the unique shape and arrangement of center guard 306c and spiral ribs 307 maximize heated air circulation along with rear guard 306a and front guard 306b.

Turning to FIGS. 5C and 5D, heating system 300 may be removably attached to vertical frame member 102 via heater mounting bracket 312. Heater mounting bracket 312 may be configured to engage housing 301 and vertical frame member 120, and may be movably positioned at different vertical heights of vertical frame member 102 in certain examples. Heater mounting bracket 312 may include front plate 312a configured to removably attach to the rear side of housing 301 via mechanical fastener. Front plate 312a may include a pair of female members or slots 313 configured to removably engage a pair of male members or hooks 314 of rear plate 312. Rear plate 312 of heater bracket 312 may be configured to movably attach to vertical frame member 120 via mechanical fastener.

Heater system 300 may be easily attached to and removed from vertical frame members 120 via heater bracket 312. Heater system 300 may further include a charging port or universal serial bus (USB) 315 for charging or power. Heater system 300 may include a rechargeable battery system within housing 301 or embedded within user interface 302. In other examples, heater system 300 may include conventional power cords and attachments to provide a conduit for external electrical power.

Although the present invention has been described in certain specific aspects, many additional modifications and variations would be apparent to those skilled in the art. In particular, any of the various processes described above may be performed in alternative sequences and/or in parallel (on different computer machines) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A portable sauna system comprising:
a cabin structure;
a cabin frame configured to engage the cabin structure;
a heating system including a protective barrier positioned on a top portion of the heating system and configured to generate heated airflow, and wherein the protective barrier is further configured to optimize heated airflow circulation; and
a heater mounting bracket configured to removably engage the heating system and the cabin frame, wherein the protective barrier further comprises:
a rear guard;
a front guard; and
a center guard, wherein rear guard comprises a horseshoe shape forming a front gap and a rear wall having a varying rear wall height, wherein a maximum rear wall height is positioned adjacent the cabin structure material, wherein the front guard is configured to engage the front gap, wherein the front guard is curvilinear having single height, and wherein the center guard comprises a series of support ribs, and wherein the center guard is spiral shaped and comprising a series of support ribs.

2. The system of claim 1, wherein the cabin frame comprises a series of collapsible metal poles configured to engage a top and a bottom, and wherein the top comprises a metal sand the bottom comprises a polymer.

3. The system of claim 1, wherein the cabin structure is collapsible.

4. The system of claim 3, wherein the cabin structure comprises a material having an internal cotton insulation layer.

5. The system of claim 4, wherein the cabin structure material comprises a dimpled pattern on an exterior of the material and on an interior of the material.

6. The system of claim 5, wherein the cabin structure further comprises an entry flap configured to close an entrance of the cabin structure, wherein the entry flap comprises a closure device, and wherein the closure device is a zipper or a magnet.

7. The system of claim 6, wherein the entry flap comprises a flap perimeter gasket configured to engage an entry perimeter gasket of the entrance.

8. The system of claim 7, wherein the flap perimeter gasket comprises an internal magnet, wherein the entry perimeter gasket comprises an internal magnet, and wherein the flap perimeter gasket is secured to the entry perimeter gasket by a magnetic force.

9. The system of claim 1, wherein the heating system comprises a user interface, wherein the user interface is a touchscreen.

10. The system of claim 1, wherein the heating system further comprises a thermostat.

11. A sauna system comprising:
a cabin structure comprising an entryway flap, wherein the entryway flap forms an opening for an occupant to enter and exit the cabin structure, and wherein the entryway flap is configured to seal the opening;
a cabin frame configured to engage the cabin structure;
a heating system; and
a heater mounting bracket configured to removably engage the heating system and the cabin frame.

12. The system of claim 11, wherein the cabin structure is collapsible.

13. The system of claim 11, wherein the cabin structure further comprises a top and a bottom, and wherein the top and the bottom comprise a metal.

14. The system of claim 11, wherein the heating system comprises a user interface touchscreen.

15. The system of claim 11, wherein the heating system comprises a guard.

16. The system of claim 11, wherein the heating system is battery powered.

17. The system of claim 11, wherein the heating system is removably coupled to a mounting bracket.

18. The system of claim 17, wherein the mounting bracket is movably coupled to the cabin frame.

19. The system of claim 11, further comprising a chair configured to seat the occupant within the cabin structure.

20. A kit for a portable sauna system comprising:
a cabin structure;
a cabin frame configured to engage the cabin structure;
a heating system including a protective barrier positioned on a top portion of the heating system and configured to generate heated airflow, and wherein the protective barrier is further configured to optimize heated airflow circulation;
a heater mounting bracket configured to removably engage the heating system and the cabin frame, wherein the protective barrier further comprises:
a rear guard;
a front guard; and
a center guard, wherein rear guard comprises a horseshoe shape forming a front gap and a rear wall having a varying rear wall height, wherein a maximum rear wall height is positioned adjacent the cabin structure material, wherein the front guard is configured to engage the front gap, wherein the front guard is curvilinear having single height, and wherein the center guard comprises a series of support ribs, and wherein the center guard is spiral shaped and comprising a series of support ribs; and
printed instructions, wherein each component is combined into a unitary packaging assembly.
